(19) United States
(12) Patent Application Publication
(10) Pub. No.: US 2009/0107832 A1
(43) Pub. Date: Apr. 30, 2009

(54) Removing contaminants from groundwater

(76) Inventor: Noel A. Shenoi, Aliso Viejo, CA (US)

Correspondence Address: STOUT, UXA, BUYAN & MULLINS LLP, 4 VENTURE, SUITE 300, IRVINE, CA, 92618, US

(21) Appl. No.: 11/786,753

(22) Filed: Apr. 11, 2007

Related U.S. Application Data
(63) Continuation of application No. 09/797,287, filed on Feb. 27, 2001, now abandoned.

(51) Int. Cl. C02F 1/04; C02F 103/06

(52) U.S. Cl. 203/11

(57) ABSTRACT

A method and apparatus for removing hydrocarbon contaminants from groundwater. The apparatus preferably removes contaminants from groundwater by heating the groundwater to a temperature at which the contaminant vaporizes and separates from the liquid groundwater. Sparge air may be passed through the groundwater to assist in separating the vaporized contaminant. Further, a vacuum may be applied to lower the vaporization temperature of the contaminant. The extracted hydrocarbons are preferably destroyed in a thermal or catalytic oxidizer while the groundwater with the vaporized contaminant removed is preferably pumped through activated carbon filters to further reduce the amount of contaminants to governmental standards.

### CROSS REFERENCE TO RELATED APPLICATION

This application is a continuation of and claims priority to U.S. patent application Ser. No. 09/797,287, filed Feb. 27, 2001 by Noel A. Shenoi, the respective disclosure of which is incorporated herein by reference in its entirety, for all purposes.

### FIELD OF THE INVENTION

The invention relates to a method and apparatus for removing hydrocarbon (“HC”) contaminants, including methyl tert-butyl ether (“MTBE”) and benzene, from contaminated groundwater.

### BACKGROUND OF THE INVENTION

In various industrial and commercial environments, including sites having gasoline service stations, dry cleaners or other industrial sites where hydrocarbons have been stored and used, the soil and underlying groundwater may become contaminated with spilled or leaked hydrocarbons. The contaminants typically may include petroleum or chlorinated hydrocarbons, with MTBE, benzene, toluene, ethylbenzenes, xylenes, tert-butyl alcohol, perchloroethane, and tetrachloroethane being some of the most common. It is desirable, therefore, to extract contaminates from groundwater to meet regulatory standards. The extraction system and method should preferably be adaptable for use at various sites and capable of removing various contaminants.

In a known treatment method, a vehicle, such as a truck, or a trailer, on which extraction and filtering equipment is mounted, is brought to a site to be cleaned. Among the equipment are a groundwater holding tank, carbon filter tanks, and a groundwater extraction device. The groundwater extraction device is generally a series of connected pipes attached at one end to the holding tank. The end opposite the holding tank is perforated and is inserted into the ground. A vacuum is applied to the pipes to draw contaminated water into the perforated end, through the pipes and into the holding tank. The groundwater is then transferred from the holding tank through a series of carbon filter tanks to remove contaminant thereby cleaning the water to an acceptable standard, which is normally determined by a government agency. When too much contaminant accumulates in the carbon filter tank “break through” occurs. Break through means that the quantity of contaminant in the water exiting the carbon filter tanks is above the acceptable threshold. At that point the system is shut down and one or more of the carbon filter tanks is replaced with a new tank, wherein each tank costs about $500. The cost of new tanks and the lost operational time to change the tanks adds to the cost of cleaning the groundwater.

Another problem is that certain contaminants, such as MTBE, are highly soluble in water. If one of these contaminants leaks into the ground it can quickly disperse throughout the groundwater. Such a contaminant can only be removed by extraction of the groundwater and separation of the contaminant. The contaminant is often separated by passing the groundwater through a carbon filter as described above.

### SUMMARY OF THE INVENTION

As used herein, the following terms have the following meanings: (1) “contaminant” means any chemical or chemicals having a boiling point lower than water and includes hydrocarbons, such as MTBE (methyl tert-butyl ether), ETBE (ethyl tert-butyl methyl ether, TAME, (tert-Amyl Methyl Ether), DIPE (diisopropyl ether), TBA (tert-butyl alcohol), BTEX (which refers to one or more of benzene, toluene, ethylbenzene and xylenes), gasoline and diesel fuel; (2) “contaminated water” means water containing a contaminant; (3) “groundwater” means water extracted from the ground regardless of the method by which it is extracted; (4) “vaporize” means to transform into a vapor; (5) “applying a vacuum” means using an external source to lower pressure; (6) “cleaned water” means groundwater separated from vaporized contaminant; and (7) “on site” means a fixed location or portable facility that is proximate water or groundwater being treated.

The invention is a method for removing contaminant from groundwater by vaporizing contaminant present in the groundwater, the vaporized contaminant separating from the liquid groundwater, thus creating cleaned water. The contaminant is preferably vaporized by heating the groundwater in a tank to a temperature at which the contaminant vaporizes and separates from the liquid groundwater. Optionally, the tank has a vacuum applied to reduce the vaporization temperature of the contaminant. Further, the groundwater may be agitated, preferably by passing a gas such as air through the groundwater, to assist in separating the vaporized contaminant from the groundwater.

The method may also include, among other things, one or more of the following steps: (1) extracting the groundwater from the ground and transferring it to the tank, the groundwater preferably being extracted using a vacuum process, (2) removing the vaporized contaminant from the tank and disposing of it, preferably by burning it, (3) removing the cleaned water from the tank, and (4) passing the cleaned water through a filter, such as one or more carbon filter tanks, to remove additional contaminant.

Also disclosed herein is a system used to practice the method and a tank used in practicing the method.

Thus, the function of the method of the invention is to remove contaminant from groundwater. The way in which it accomplishes this function is to vaporize at least some of the contaminant, which separates from the liquid groundwater. The result is cleaned water, which can then have additional contaminants removed. Among the benefits of the invention are: (1) cost effectiveness as compared to known methods for site clean up, (2) quick mobilization to a clean-up site by being installed on a mobile unit, such as a truck or trailer, and (3) faster site cleaning than known methods.

The cost effectiveness and faster cleaning are attributable in part to the fact that the method of the invention does not rely exclusively on filters to remove contaminant. Much of the contaminant is removed when it is vaporized and separates from the liquid groundwater. Therefore, if filters, such as carbon filters, are used, they filter a smaller amount of contaminant and last longer. This either eliminates the need for filters or greatly reduces the number of filters used to filter a given amount of groundwater, which reduces material costs and maintenance time.

### BRIEF DESCRIPTION OF THE DRAWING

FIG. 1 is a partial schematic diagram illustrating the process and apparatus of the preferred embodiment of the invention.

FIG. 2 is an enlarged view of the partial schematic diagram of FIG. 1, illustrating the process and apparatus of the preferred embodiment of the invention.

FIG. 3 generally illustrates the preferred method of extracting groundwater according to the invention.

### DETAILED DESCRIPTION OF THE PREFERRED EMBODIMENT

The invention is preferably used to remove hydrocarbon contaminants from water, but can be used to remove any contaminant from any liquid. Most preferably, the invention is used to remove hydrocarbon oxygenates such as MTBE, ETBE, TAME, DIPE, aromatic hydrocarbons, such as BTEX, or fuels such as gasoline or diesel fuel.

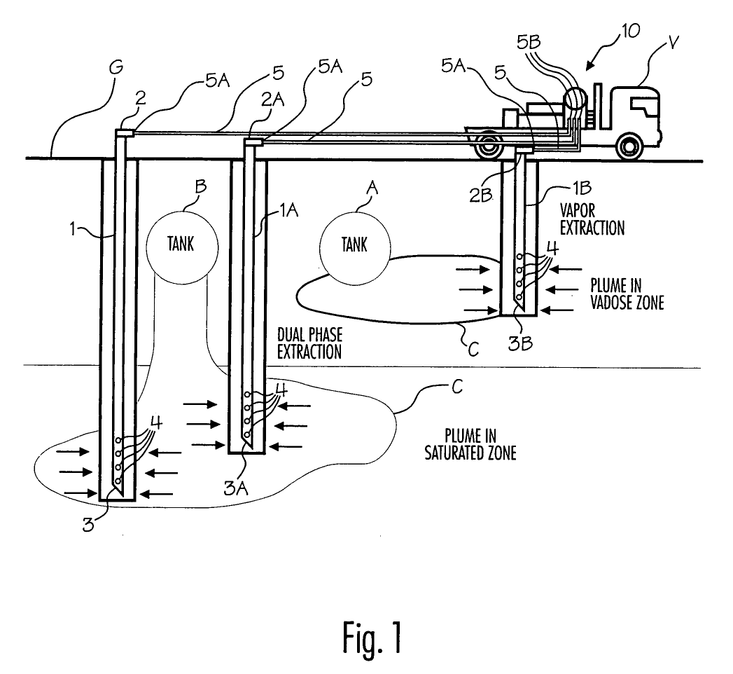

Turning now to the drawing wherein the purpose is for describing a preferred embodiment and not to limit same, FIG. 1 illustrates a situation in which fuel has leaked from two tanks, A and B, into ground G. The fuel itself is a contaminant C that contains other contaminant C, such as MTBE.

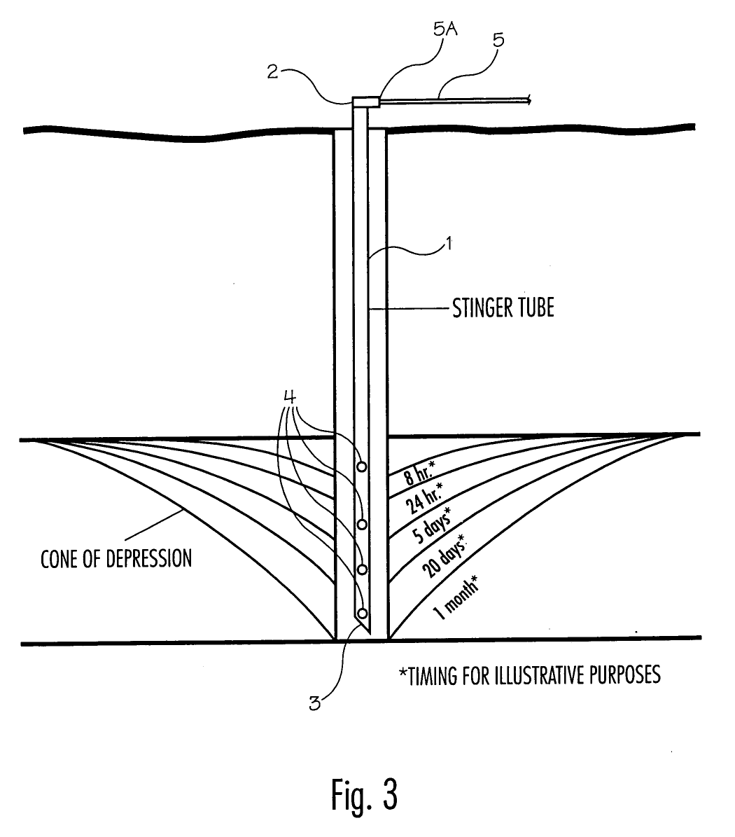

Vacuum pipes 1, 1A, and 1B each have respective first ends 2, 2A and 2B, second ends 3, 3A and 3B and perforations 4. Perforations 4 may be disposed along an entire length of vacuum pipes 1, 1A and 1B (as shown in FIGS. 1 and 3), or alternatively, perforations 4 may only be disposed proximate ends of the vacuum pipes 1, 1A and 1B to be submerged in the ground water.

Flexible hoses 5 each have a first end 5A and a second end 5B. First ends 2, 2A and 2B are connected respectively to a first end 5A of a hose 5. The purpose of each vacuum pipe 1, 1A and 1B is to be inserted into the ground and extract contaminated groundwater therefrom (preferably by the application of vacuum). Any device or devices capable of performing this function may be used. The hoses transfer the extracted groundwater to system 10, described below. Any device or devices, including submersible pumps, may be used to transfer groundwater to system 10, and any number of pipes and hoses may be used to extract contaminated groundwater and transfer it to system 10.

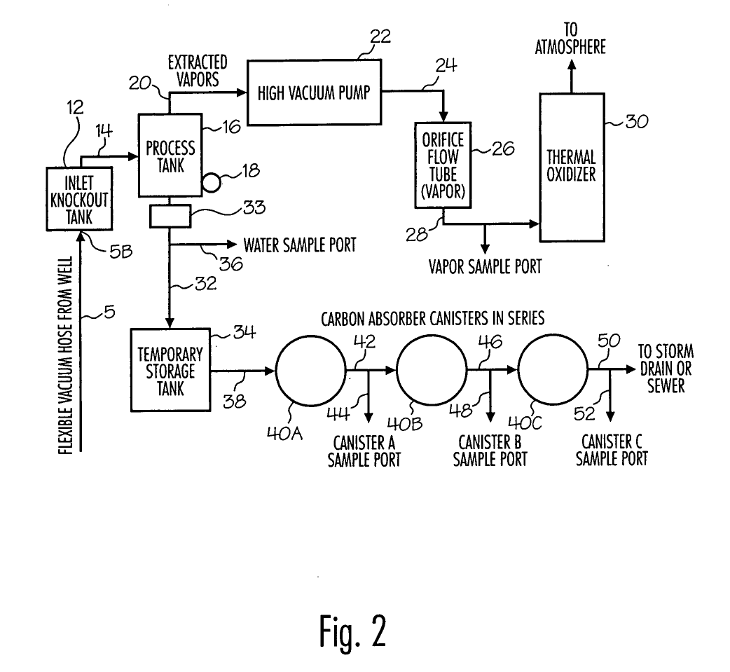

A system 10 for treating extracted groundwater is preferably mounted on a vehicle V. In a preferred embodiment, the portions of system 10 located on vehicle V are obtained from and assembled onto vehicle V by SOLLECO LLC. Turning now to FIG. 2, system 10 preferably includes an inlet knockout (or holding) tank 12. Contaminated groundwater is transferred from each of hoses 5 into inlet knockout tank 12. Tank 12 temporarily retains, or holds, extracted liquids and any structure capable of performing this function may be used. Alternatively, tank 12, or similar structure, may not be included as part of system 10. Tank 12 is preferably supplied by SOLLECO LLC, has approximately a 28″ inside diameter, an approximate height of 5′, is manufactured from ¼″ thick steel, and has a capacity of approximately 200 gallons. However, it should be noted that the size and materials of tank 12 may be selected based on the desired characteristics taking into consideration performance and logistics requirements of system 10.

A conduit 14 connects tank 12 to a process tank 16. The function of each of the conduits herein is to transfer liquid and/or vapor, depending upon the conduit, and any structure capable of performing the function of a respective conduit may be used. Each of the conduits described herein is manufactured of ¼″ thick steel and has an inner diameter of 4″. Tank 16 preferably has an agitator [not shown], which is preferably a tube connected to a valve 18 on tank 16 to introduce compressed air at a preferred pressure of below 1 pound per square inch (psi) or atmospheric air, which is introduced into process tank 16 under vacuum. Tank 16 also includes a heating element [not shown]. The heating element is preferably positioned on or near the inner annular wall of tank 16 and transfers heat to the groundwater in the tank in order to vaporize at least some of contaminant C. Tank 16 is where, in the preferred embodiment, contaminant is separated from groundwater, in the method discussed below. Any device or devices capable of performing this function may be used to practice the invention. A preferred embodiment for vacuum pipes 1, hoses 5, vehicle V, inlet tank 16, conduit 14, agitator 18, and the heating element are set forth in the following chart.

| Item | Make/Manufacturer/Model # |
|---|---|
| Vacuum Pipes 1 | 1″ or 1¼″ ID made of ¼″ thick steel |
| | having perforations ¼″ in diameter |
| Flexible Hoses 5 | 1″ or 1¼″ Series BW Water Hose from |
| | Kuriyama |
| Vehicle V | GMC 2001 truck with 17′ flatbed. |
| Inlet Tank 16 | ¼″ steel, internally braced to withstand |
| | high vacuums to 29″ Hg. Approximate 60″ |
| | height, 28″ diameter with a mist pad on |
| | top. Connections and fittings are in the |
| | side of the tank. Manufacturer - |
| | SOLLECO LLC, Anaheim, CA. |
| Conduit 14 | 4″ ID steel pipe made from ¼″ thick steel. |
| | Manufacturer - SOLLECO LLC, Anaheim, |
| | CA. |
| Agitator 18 | ½″ ID PVC (polyvinyl chloride) pipe with |
| | ⅛″ holes (minimum 20 holes) to let air or |
| | gas enter inlet tank 16. Valve 19 is a ½″ |
| | ball valve, made by Apollo. |
| Heating Element | ½″ ID copper coil is 100′ long and is |
| | placed in inlet tank 16 to carry heated water |
| | (preferably over 100° F.) to heat |
| | groundwater in inlet tank 16, and is |
| | assembled in tank 16 by SOLLECO. The |
| | heating element could also be a heating |
| | immersion strip, such as 5000 watt copper |
| | thermostatically controlled brushing |
| | immersion heater manufactured by |
| | Grainger, #2E932. |

A conduit 20 connects process tank 16 to a high vacuum pump 22. A conduit 24 connects pump 22 to an orifice flow tube 26. A conduit 28 connects tube 26 to a thermal/catalytic oxidizer 30. Oxidizer 30 is used to burn, or oxidize, contaminant, releasing the exhaust into the atmosphere. Any device, however, capable of performing this function may be used.

A conduit 32 connects process tank 16 to temporary storage tank 34. Pump 33 is disposed in conduit 32 to pump liquid from tank 16 to tank 34. A water sample port 36 is connected to conduit 32 and enables an operator to sample water exiting process tank 16. Temporary storage tank 34 temporarily stores cleaned groundwater that has exited process tank 16. Any device capable of performing this function may be utilized. Alternatively, system 10 may not include a temporary storage tank or similar structure. Temporary storage tank 34 is preferably a 550-gallon PVC storage tank to temporarily hold groundwater. A conduit 38 connects temporary storage tank 34 to one or more filters. Preferably the one or more filters are granular activated carbon filters 40A, 40B and 40C. As shown in FIG. 2, filters 40A and 40B, and 40C are connected by, respectively, conduits 42 and 46. An exit conduit 50 extends from tank 40C. A canister 40A sample port 44 is used to sample water exiting carbon filter 40A. A canister 40B sample port 48 is used to sample water exiting carbon filter 40B. A canister 40C sample port 52 is used to sample water exiting carbon filter 40C.

Following is a description of preferred embodiments of conduit 20, pump 22, conduit 24, orifice tube 26, conduit 28, oxidizer 30, conduit 32, storage tank 34, Sample Port 36, conduit 38, conduit 42, conduit 46, conduit 50, carbon filters 40, and pump 33.

| Item | Description |
|---|---|
| Conduit 20 | 4″ ID steel of ¼″ thickness manufactured |
| | by SOLLECO LLC. |
| Pump 22 | 25 HP liquid ring blower, such as that |
| | manufactured by STERLING, Model |
| | #560AB8310A0, powered by a direct- |
| | driven electric motor 25 HP, such as that |
| | manufactured by U.S. Electric Motors, |
| | Model #T811A, 240 V, 3 phase LRP, in |
| | order to create vacuum up to 29″ Hg. |
| Conduit 24 | 4″ ID steel of ¼″ thickness manufactured |
| | by SOLLECO LLC. |
| Orifice Tube 26 | 4″ ID stainless steel tube with a 2.75″ ID |
| | Orifice to measure vapor flow rate in cubic |
| | feet per minute. Manufactured by DICK |
| | MUNNS COMPANY, Los Alamitos, CA. |
| Conduit 28 | Preferably the same as conduit 20 and 24. |
| Thermal/Catalytic | 24″ ID made of 3/16″ thick steel stock with |
| Oxidizer 30 | a 5″ thick fiber insulation inside to protect |
| | the outer metal. Manufacturer - |
| | SOLLECO LLC. It thermally incinerates |
| | hydrocarbons in the vapor and greatly |
| | reduces emissions to atmosphere. |
| Conduit 32 | 1″ ID steel pipe Sch 40 Manufactured by |
| | SOLLECO LLC. |
| Storage Tank 34 | 550 gallon PVC storage tank to temporarily |
| | hold groundwater. |
| Sample Port 36 | ¼″ brass ball valve with ¼″ opening |
| Conduit 38 | 1″ ID PVC or plastic base Manufactured by |
| Conduit 42 | Kuriyama. |
| Conduit 46 | |
| Conduit 50 | |
| Carbon Filters 40 | 200 Series carbon absorber with virgin |
| | coconut carbon from U.S. Filter Westates. |
| | Model #200SCA/CC602BB |
| Pump 33 | 1 HP Goulds Model 3656 centrifugal pump |
| | powered by a Balder JMM 35461 1 h.p. |
| | electric motor (pumps liquid conduit 32 |
| | from tank 16 to tank 34). |

In practice, groundwater is extracted by pipes 1 and is transferred via hoses 5 into holding tank 12. The groundwater is then transferred to tank 16 where enough heat is supplied by the heating element to vaporize at least some of the contaminant, but not vaporize any significant amount of groundwater. The vaporized contaminant separates from the liquid groundwater.

Preferably, vacuum is applied to tank 16 by pump 22 through conduit 20. The vacuum lowers the temperature at which contaminant C vaporizes, and if enough vacuum is applied no heat need be applied by the heating element to vaporize contaminant C.

The groundwater is also preferably agitated to assist in separating vaporized contaminant. The groundwater is preferably agitated by introducing gas (preferably air) through valve 18. Other agitation devices, such as an impeller, may be used.

After the vaporized contaminant separates from the liquid groundwater it passes through conduit 20, pump 22, conduit 24, orifice flow tube 26, conduit 28 and into oxidizer 30 where it is burned, preferably to governmental emission standards. Cleaned water exits tank 16 and passes through conduit 32 to temporary storage tank 34. It passes out of tank 34 through conduit 38 and preferably into one or more filters 40A, 40B and 40C. The filter(s) remove additional contaminant, preferably lowering the amount in the cleaned water to an acceptable government standard. The water is then expelled through conduit 50, preferably onto the ground at the site.

FIG. 3 illustrates the groundwater extraction process. Pipe or stinger tube 1 is inserted into the ground and over a period of time, or specifically depicted, the cone of depression for the groundwater around the well is increased, thereby allowing additional soil to be affected by vapor extraction to remove hydrocarbons from the exposed soil.

The system used to practice the invention can have any throughput, but preferably has the capacity of extracting a minimum of about 10 gallons per minute from the ground. The technical specification of the preferred system is as follows:
(1) 450 cubic feet per minute (CFM) maximum air flow for the vacuum pump;
(2) 29″ of mercury (Hg) maximum vacuum applied by the vacuum pump;
(3) 50 gallons per minute (gal/min) maximum water extraction from the ground;
(4) 600,000 to a maximum of 1,000,000 BTU/hr catalytic oxidizer; and
(5) a minimum 99% or greater DRE (destination removal efficiency), which is the total amount of contaminate removed from the groundwater by system 10.

System 10 is preferably fully mobile and functions without hookup to site utilities, such as water or sewer. System 10 is preferably rendered mobile by placing it on vehicle V.

### EXAMPLE 1

The invention was used in a 24-hour dual phase (i.e., vapor and groundwater) extraction pilot test. The subject site had elevated concentrations of petroleum hydrocarbons, including the oxygenated gasoline additives MTBE and TAME, in the soil and groundwater.

The lithology of the site generally consisted of sand/silty sand 0-15 feet below ground surface (“bgs”), clay and silt/silty clay at 15-55 feet bgs, and sand/gravelly sand at >55 feet bgs. Shallow groundwater was located in a thin saturated zone at approximately 24 feet bgs.

The results of the extraction pilot test indicated an effective radius of influence of the extraction device of approximately 29 feet. Extracted groundwater was treated utilizing the system and method according to the invention on site to treat groundwater and expel water meeting applicable governmental standards. Approximately 495 pounds of hydrocarbons were burned during the 24-hour test. The results of the groundwater samples are presented in Table 1.

TABLE 1

| | Prior To | | After | | | Carbon | |
|---|---|---|---|---|---|---|---|
| | Extraction | | Treatment | | Percent | Polishing Post | Percent |
| Parameter | (14) | | Process (36) | | Reduction | Treatment (52) | Reduction |
| MtBE | 360,000 | μg/L | 6,740 | μg/L | 98% | ND (<0.5 μg/L) | 100% |
| TPHg | 228,000 | μg/L | 11,300 | μg/L | 95% | ND (<50 μg/L) | 100% |
| TAME | 2,590 | μg/L | 25.3 | μg/L | 99% | ND (<0.5 μg/L) | 100% |
| Benzene | 33,700 | μg/L | 267 | μg/L | 99% | ND (<0.5 μg/L) | 100% |
| Toluene | 52,700 | μg/L | 987 | μg/L | 99% | ND (<0.5 μg/L) | 100% |
| Ethylbenzene | 6,580 | μg/L | 162 | μg/L | 98% | ND (<0.5 μg/L) | 100% |
| Xylenes | 40,900 | μg/L | 1,497 | μg/L | 96% | ND (<1.0 μg/L) | 100% |
| Napthalene | 10,200 | μg/L | 147 | μg/L | 98% | ND (<0.5 μg/L) | 100% |

TPHg—Total Petroleum Hydrocarbons - Gasoline Range
ND (<0.5 μg/L)—Not Detected Above the Laboratory Reporting Limit of 0.5 μg/L

Having now described a preferred embodiment, modifications or alterations that do not depart from the spirit of the invention may occur to others. For example, while the present invention has been described in reference to treatment of ground water, the invention may be equally implemented to clean water from any source in addition to groundwater (e.g., rivers, lakes, ponds, swimming pools, and reservoirs). The invention is thus not limited to the preferred embodiment, but is instead set forth in the appended claims and legal equivalents thereof. Unless specifically stated otherwise, the method steps of any of the following claims may be performed in any order capable of vaporizing contaminate and having it separate from liquid groundwater.

What is claimed is:

1. A method for removing contaminant from groundwater, the method comprising the steps of:
(a) extracting groundwater including contaminate from the ground;
(b) placing the extracted groundwater into a tank;
(c) applying a vacuum to the tank;
(d) heating the extracted groundwater to a temperature at which at least a portion of the contaminant vaporizes and separates from the extracted groundwater, thereby forming cleaned water;
(e) removing the vaporized contaminant from the tank;
(f) removing the cleaned water from the tank; and
(g) burning the separated, vaporized contaminant.

2. The method of claim 1 wherein the contaminant comprises MTBE.

3. The method of claim 1 that further includes the step of passing the cleaned water through a filter to remove additional contaminant.

4. The method of claim 1 that further includes the step of agitating the ground water to assist in separating the contaminant.

5. The method of claim 4 wherein the ground water is agitated by passing a gas through it to assist in separating the contaminant.

6. The method of claim 5 wherein the gas is air.

7. The method of claim 1 wherein the temperature is 60° F. to 200° F.

8. The method of claim 3 wherein the filter is an activated carbon filter.

9. The method of claim 8 wherein the carbon filter is one or more tanks containing activated carbon.

10. The method of claim 1 wherein the groundwater is extracted from the ground by vacuum.

11. The method of claim 1 wherein the groundwater is heated on site and the contaminant vaporizes and separates on site.

12. The method of claim 1 wherein the vaporized contaminant is burned on site.

13. The method of claim 3 wherein the cleaned water is passed through the filter on site.

14. The method of claim 13 wherein, after being passed through the filter, the cleaned water has a level of contaminate at or below a government standard applicable for water at the locale where the cleaned water is released into the environment.

15. A method for removing a contaminate from groundwater, the method comprising:
(a) placing ground water containing the contaminate into a tank, wherein the tank is on a vehicle;
(b) applying a vacuum to the tank to create a pressure at which the contaminate vaporizes and separates from the groundwater; and
(c) agitating the groundwater to assist in separating the contaminate.

16. The method of claim 15 that further includes the step of heating the groundwater.

17. The method of claim 15 that further includes the step of burning the vaporized contaminant.

18. The method of claim 15 wherein the contaminant comprises MTBE.

19. The method of claim 15 wherein after the contaminant vaporizes and separates from the groundwater, the groundwater is passed through a filter to remove more contaminant.

20. The method of claim 15 wherein the groundwater is agitated by passing a gas through it.

21. The method of claim 19 wherein the filter is an activated carbon filter.

22. The method of claim 21 wherein the filter is one or more tanks containing activated carbon.
